(19) United States
(12) Patent Application Publication
(10) Pub. No.: US 2009/0072182 A1
(43) Pub. Date: Mar. 19, 2009

(54) FIRE FIGHTING AND COOLING COMPOSITION

(75) Inventor: Paul H. Berger, Rome, NY (US)

Correspondence Address: HAYNES AND BOONE, LLP;IP Section, 2323 Victory Avenue, Suite 700, Dallas, TX, 75219, US

(73) Assignee: BAUM'S FLAME MANAGEMENT, LLC, Addison, TX (US)

(21) Appl. No.: 11/857,927

(22) Filed: Sep. 19, 2007

(51) Int. Cl. A62D 1/02

(52) U.S. Cl. 252/3; 252/8.05

(57) ABSTRACT

The present disclosure provides a fire fighting and cooling composition. The composition includes a non-ionic surfactant selected from alkyl polyglycosides, N-alkyl-2-pyrrolidones, and combinations thereof. The alkyl polyglycoside non-ionic surfactants have a substituted or unsubstituted alkyl side chain of from 6 to 18 carbon atoms and the N-alkyl-2-pyrrolidones have a substituted or unsubstituted alkyl side chain of from 8 to 10 carbon atoms. The composition also includes an anionic surfactant selected from alkyl ether sulfates, alkyl ether phosphates, and combinations thereof. The composition further includes an amphoteric surfactant. In the composition, the non-ionic surfactant is present at a concentration of from about 0.25% to about 13.0% by weight, the anionic surfactant is present at a concentration of from about 10.0% to about 50.0% by weight, and the amphoteric surfactant is present at a concentration of from about 0.5% to about 15.0% by weight.

### TECHNICAL FIELD

The present embodiments generally relate to a chemical composition for the suppression and control of fires involving liquid hydrocarbons and/or polar solvents.

### BACKGROUND

Many fire fighting compositions have employed the mechanism of using a foam blanket to smother the fire and isolate the fuel from an oxygen source that will support the combustion of the fuel. However, many such fire fighting compositions do not produce stable foams in the presence of extremely volatile liquid hydrocarbons and polar solvents. Some fire fighting compositions have used perfluorooctyl sulfate and perfluorooctyl betaine surfactants to lower the interfacial tension between the water layer and the hydrocarbon surface. This lowered interfacial tension allows for a uniform aqueous film to seal the hydrocarbon surface and stabilize the foam formation.

Fluorosurfactants, however, are very chemically stable, making them invulnerable to many forms of degradation. Rather than fully metabolizing such fluorosurfactants, soil bacteria are only able to oxidize the fluorine free portions of the perfluorooctyl betaine molecules, resulting in perfluorooctanoic acid. At test facilities where repeated use of these surfactants has occurred, the surfactants and the perfluorooctanoic acid derivatives thereof have descended through the soil without being degraded by the normal bacterial complement, and have contaminated the groundwater. Movement of the fluorocarbon surfactants and the perfluorooctanoic acid derivatives thereof through the groundwater has resulted in contamination of potable water supplies. Entrance of these surfactants and the perfluorooctanoic acid derivatives thereof into sanitary sewer systems has resulted in the disabling of waste treatment facilities, causing untreated sewage to be discharged into waterways.

The chemical and biological stability of fluorosurfactants has caused them to be classified as environmentally persistent. Studies have found perfluorooctyl sulfate, perfluorooctyl betaine and perfluorooctanoic acid residues in numerous animal tissue samples. With no elimination or metabolic pathways for perfluorooctyl sulfate, perfluorooctyl betaine and perfluorooctanoic acid they are considered to be bioaccumulative. Reproductive studies with these materials in rats have shown they cause an increased level of reproductive problems. Consequently, the indiscriminate use of such fluorosurfactants is an environmental threat.

Firefighting foam compositions containing fluorosurfactants are excellent at sealing pools of burning hydrocarbons. The pool surface, comprised essentially of only two dimensions (length and width), is readily sealed off. If, however, a hydrocarbon fire is comprised of three dimensions (length, width and height) and pressurized or flowing fuel, such firefighting foam compositions containing fluorosurfactants are not effective.

Prior firefighting compositions that do not contain fluorosurfactants, such as those represented by U.S. Pat. No. 5,585,028 and Baum's Novacool UEF®, have been generally effective at suppressing and controlling fires involving liquid hydrocarbons and/or polar solvents. However, such compositions have required an undesirably long period of time to suppress and control such liquid hydrocarbon and/or polar solvent fires.

### DETAILED DESCRIPTION

It is to be understood that the following disclosure provides many different embodiments, or examples, of the present invention for implementing different features of various embodiments of the present invention. Specific examples of components are described below to simplify and exemplify the present disclosure. These are, of course, merely examples and are not intended to be limiting.

Embodiments of the present invention include a fire fighting and cooling composition for the suppression and control of liquid hydrocarbon and/or polar solvent fires. According to certain embodiments, the fire fighting and cooling composition includes a non-ionic surfactant, an anionic surfactant, an amphoteric surfactant and water. Other embodiments of the fire fighting and cooling composition of the present invention, include either two nonionic surfactants or two anionic surfactants in place of the amphoteric surfactant. According to still other embodiments of the present invention, the fire fighting and cooling composition includes optional ingredients, including polysaccharides, such as salts such as alkali metal salts and alkaline earth metal salts as well as organic acids such as citric acid.

According to certain embodiments, the fire fighting and cooling composition is diluted in water at a concentration of from about 0.01% to about 12.0% by volume.

Also according to certain embodiments, the fire fighting and cooling composition may be used in combination with conventional fire fighting equipment. In such embodiments, the fire fighting and cooling composition can be batch mixed in fire fighting equipment tanks or can be metered into a water stream using conventional fire fighting proportioning equipment.

According to certain embodiments of the fire fighting and cooling composition of the present invention, the non-ionic surfactant is present at a concentration of from about 0.25% to about 13.0% by weight, the anionic surfactant is present at a concentration of from about 10.0% to about 50.0% by weight, the amphoteric surfactant is present at a concentration of from about 0.5% to about 15.0% by weight with the balance being made up of water. According to certain embodiments of the present invention, the fire fighting and cooling composition also includes a water soluble polysaccharide present at a concentration of from about 0.1% to about 1.0% by weight.

As used herein, all percentages, parts and ratios are by weight unless otherwise indicated. According to embodiments of the present invention in which the composition includes alkyl substituted surfactants, such alkyl moieties include substituted or unsubstituted alkyl moieties. Typical substituted constituents include hydroxyl, carboxyl and amino radicals. However, other constituents that may be substituted on the alkyl moieties will be readily apparent to those skilled in the art.

### Non-Ionic Surfactants

According to certain embodiments of the present invention, the fire fighting and cooling composition includes at least one non-ionic surfactant present at from about 0.25% to about 13.0% by weight of the composition or from about 3.0% to about 12.0% by weight of the composition. According to such embodiments, suitable non-ionic surfactants include water-soluble alkyl polyglycosides and N-alkyl-2 pyrrolidones. The water-soluble alkyl polyglycosides have an alkyl or hydroxy alkyl moiety of from 6 to 18 carbon atoms and optionally one or two additional alkyl moieties bonded to the polyglycoside group wherein such additional alkyl moieties include from 1 to 3 carbon atoms and are optionally substituted with one or more hydroxyl groups. The N-alkyl-2 pyrrolidones have an alkyl or hydroxy alkyl moiety of from 8 to 10 carbon atoms bonded to the heterocyclic nitrogen atom. According to certain embodiments of the present invention, mixtures of two or more non-ionic surfactants are employed in the fire fighting and cooling composition. For instance, according to certain embodiments of the present invention, the fire fighting and cooling composition includes a mixture of an alkyl polyglycoside and an N-alkyl-2 pyrrolidone.

The alkyl polyglycoside is generally be represented by the formula:

H-(Z)ₙ-O—R

where “Z” is a saccharide residue having 5 or 6 carbon atoms, “n” is a number having a value between 1 and about 6, and “R” represents an alkyl group, typically having from 6 to 18 carbon atoms. The “n” represents the average number of saccharide residues in a particular sample of alkyl polyglycoside. As defined herein, the term “alkyl polyglycoside” also encompasses alkyl monosaccharides, i.e., where “n” equals 1.

It will be understood that as referred to herein, an “alkyl polyglycoside” may consist of a single type of alkyl polyglycoside molecule or, as is typically the case, may include a mixture of different alkyl polyglycoside molecules.

Commercially available examples of suitable alkyl polyglycosides include Glucopon® 220, 215 CSUP, 225, 425, 600 and 625, all available from Cognis Corporation. Glucopon® 220 is an alkyl polyglycoside having an average of 1.5 glucosyl residues per molecule and in which the alkyl group contains 8 to 10 carbon atoms (average carbons per alkyl chain—9.1). Glucopon®215 CSUP is an alkyl polyglycoside having an average of 1.6 glucosyl residues per molecule and in which the alkyl group contains 8 to 10 carbon atoms. Glucopon®225 is an alkyl polyglycoside having an average of 1.7 glucosyl residues per molecule and in which the alkyl group contains 8 to 10 carbon atoms (average carbon per alkyl chain—9.1). Glucopon®425 is an alkyl polyglycoside having an average of 1.5 glucosyl residues per molecule and in which the alkyl group contains 8 to 16 carbon atoms (average carbons per alkyl chain—10.3). Glucopon®600 is an alkyl polyglycoside having an average of 1.4 glucosyl residues per molecule and in which the alkyl group contains 12 to 16 carbon atoms (average carbons per alkyl chain—12.8). Glucopon®625 is an alkyl polyglycoside having an average of 1.6 glucosyl residues per molecule and in which the alkyl group contains 12 to 16 carbon atoms (average carbons per alkyl chain—12.8). Another example of a suitable commercially available alkyl polyglycoside is TL 2141, a Glucopon®220 analog available from ICI.

According to certain embodiments of the present invention, the nonionic surfactant is a mixed alkyl polyglycoside (from palm oil fatty acids), primarily dodecyl polyglycoside and decyl polyglycoside. A commercially available example of which is Glucopon® 625 FE which is available from Cognis Corporation.

A commercially available example of a suitable N-alkyl-2-pyrrolidone is N-octyl-2-pyrrolidone which is available from ISP Technologies, Inc. as Surfadone® LP-100.

According to certain embodiments of the present invention, the nonionic surfactant suitable for use in the fire fighting and cooling composition is dimethyl dodecylamine oxide, but only on the condition that: a) the anionic surfactant is isopropanolamine C₆-C₈ alkyl ether sulfate and the amphoteric surfactant is an imidazoline; or b) the anionic surfactant is monoethanolamine C₁₀-C₁₂ alkyl ethoxy phosphate. A commercially available form of dimethyl dodecylamine oxide is Barlox® 12 made by Lonza.

### Anionic Surfactants

According to certain embodiments of the present invention, the fire fighting and cooling composition includes an anionic surfactant present at a concentration of from about 10.0% to about 50.0% by weight. According to such embodiments, suitable anionic surfactants include alkyl ether sulfates, alkyl ether phosphates and combinations thereof.

According to certain embodiments, the weight ratio of the non-ionic surfactant to the anionic surfactant is from 1:99 to 1:1.

According to certain embodiments, the anionic surfactant is present as an alkyl ether sulfate having the formula: (RO(C₂H₄O)ₓSO₃)M where R is a substituted or unsubstituted alkyl group having from 6 to 10 carbon atoms, x ranges from 1 to 30, and M is ammonium or substituted ammonium (organic amine).

Such alkyl ether sulfates may be derived by ethoxylating an alcohol having 6 to 10 carbon atoms, preferably 6 to 8 carbon atoms with ethylene oxide and then sulfating the ethoxylated alcohol. The resulting composition is then reacted with a base to form an ammonium, or substituted ammonium salt. A commercially available example of such an alkyl ether sulfate surfactant is Witcolate™ 1259 made by Akzo Nobel.

According to certain embodiments, the anionic surfactant is present as an alkyl ether phosphate having the formula: [RO(C₂H₄O)ₓPO₃]M where R is a substituted or unsubstituted alkyl group having from 6 to 18 carbon atoms, x ranges from 1 to 30, and M is ammonium or substituted ammonium (organic amine). According to certain embodiments, the alkyl ether phosphate surfactant is present in the fire fighting and cooling composition at a concentration of about 2.0% to about 8.0% by weight.

The above described anionic surfactants are commercially available in both acid and neutralized forms. Those available as acids can be converted to a desired salt by direct neutralization with the appropriate base. For instance, suitable alkyl ether phosphate surfactants may be prepared by reacting Cola®Fax 3690 an alkyl phosphate ester which is commercially available from Colonial Chemical, Inc. with triethanolamine or monoethanolamine to yield triethanolamine C₁₀-C₁₂ alkyl ether phosphate and monoethanolamine C₁₀-C₁₂ alkyl ether phosphate, respectively. Those available in a neutralized form can be used to develop a desired alkali metal or alkaline earth metal salt by ion exchange. Another suitable alkyl ether phosphate surfactant may be prepared by reacting Cola®Lube 3407 CI a phosphate ester which is commercially available from Colonial Chemical, Inc. with triethanolamine to yield triethanolamine C₁₈ alkyl ether phosphate.

### Amphoteric Surfactants

According to certain embodiments of the present invention, the fire fighting and cooling composition includes at least one amphoteric surfactant present at from about 0.5% to about 15.0% by weight or from about 1.0% to about 10.0% by weight. According to such embodiments, suitable amphoteric surfactants include betaines and imidazolines.

According to certain embodiments, the amphoteric surfactant has an alkyl moiety of 8-28 carbon atoms, a positively charged amino group, and a negatively charged carboxylic acid group. Suitable amphoteric compounds have the following formula:

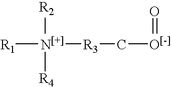

where R₁-R₄ are independently selected from the group consisting of substituted and unsubstituted alkyl constituents, substituted and unsubstituted cycloalkyl constituents, substituted and unsubstituted aryl constituents, and ethoxylated hydroxyl groups containing 1-10 ethylene oxide units.

According to certain embodiments of the present invention, the amphoteric surfactant is an acylamidoalkylbetaine having the formula:

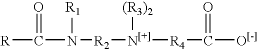

where R is a substituted or unsubstituted alkyl or alkylaryl group having from 6 to 12 carbon atoms, R₁ is a hydrogen or substituted or unsubstituted alkyl group having from 1 to 6 carbon atoms, R₂ is a substituted or unsubstituted alkylene group having from 1 to 10 carbon atoms, R₃ is a substituted or unsubstituted alkyl group having from 1 to 6 carbon atoms or an ethoxylated hydroxyl group containing 1-10 ethylene oxide units, wherein the ethoxylated hydroxyl group has the formula:

HC—(OC₂H₅)₁₋₁₀

and where R₄ is a substituted or unsubstituted alkylene group containing 1-6 carbon atoms.

According to one embodiment, the acylamidoalkylbetaine includes octylamidopropyldimethylbetaine, dodecylamidopropylbetaine, dimethylbetaine, C₈ acylamidohexyldiethylbetaine, C₁₂₋₁₄ acylamidopropylbetaine, or combinations thereof. A commercially available example of a C₁₂-C₁₄ acylamidopropyl dimethyl betaine amphoteric surfactant includes Cola®Teric COAB made by Colonial Chemical Inc.

According to certain embodiments of the present invention, the amphoteric surfactant includes an imidazoline group. Examples of suitable imidazolines include C₆₋₁₆ sodium dicarboxyethyl alkyl phosphoethyl imidazoline, C₈₋₁₂ alkyl imidazoline, and combinations thereof. Commercially available examples of such amphoteric surfactants include Cola® Zoline C and Cola®Teric AP made by Colonial Chemicals, Inc.

### Polysaccharides

According to certain embodiments of the present invention, the fire fighting and cooling composition includes a polysaccharide. Polysaccharides are soluble in water and insoluble in polar solvents. It is believed that polysaccharides are chemically active to isolate the foam from polar solvent vapors and serve to slow the drainage of water from the foam into the fuel. As such, polysaccharides will become insoluble in fuels that include liquid hydrocarbons and polar solvents, resulting in a suppressant interface serving as an additional physical barrier to the vapors. In one embodiment of the present invention, polysaccharides are present from about 0.1% to about 1.0% by weight. Examples of polysaccharides utilized in the fire fighting and cooling composition include water soluble xanthan gum, guar gum and combinations thereof. Commercially available examples of suitable xanthan gums are Kelzan® S and Kelzan® ST made by CP Kelco.

### Salts and Organic Acids

According to certain embodiments of the present invention, the fire fighting and cooling composition includes an alkali metal or alkaline earth metal salt or organic acids to control viscosity or pH. In addition, they may be sources for ionic exchange. The alkali metal salts, alkaline earth metal salts and organic acids include magnesium chloride, magnesium sulfate, magnesium citrate, calcium chloride, sodium chloride, sodium sulfate, sodium citrate, citric acids, and mixtures thereof. In one embodiment, the salts or acids are present at concentrations of from about 0.01% to about 5.0% by weight.

According to certain embodiments, the fire fighting and cooling composition is mixed with water through standard fire fighting equipment and applied to hydrocarbon or polar solvent fires at a concentration of about 0.01% to about 12.0% by volume (e.g. about 0.01% to about 12% fire fighting and cooling composition and the remainder water); or at a concentration of about 0.1% to about 6.0% by volume. Fires involving lower volatile liquid hydrocarbons will only require application from the low end of the concentration range while fires involving higher volatile liquid hydrocarbons and polar solvents will require application from the high end of the concentration range) e.g. diesel fuel about 0.2% by volume application; high octane unleaded gasoline about 3.0% by volume application).

In operation, when the fire fighting and cooling composition is applied to hydrocarbon or polar solvent fires, a mixture layer is formed at the fuel surface which consists of a double concentration gradient with a high concentration of fuel and a low concentration of water and surfactant at the bottom, and a high concentration of water and surfactant and a low concentration of fuel at the top. A stable environment is created for the foam by emulsifying the hydrocarbons and polar solvents into an aqueous phase that suppresses vapor from migrating into the foam bubbles and destabilizing the foam. According to certain embodiments, the addition to the fire fighting and cooling composition of various salts, acids and polysaccharides facilitates stable foam formation.

The following examples are illustrative of the compositions and methods discussed above.

### EXAMPLES

The compositions shown in Tables 2-5 below were prepared by simple mixing of ingredients and were then evaluated by comparing their extinguishment times when applied at a concentration of 1.0% in water, through commercially available spray equipment, to a 246 cm² pan containing 40 ml hexane on a 1 cm deep water base. The components of the compositions shown in Tables 2-5 are set forth as a percentage by weight of the composition. The rate of volume of fluid applied was constant for each test at 0.2438ml/minute/cm². Three test replicates were run on each composition, with the mean time shown in Tables 2-5 below. The commercially available forms and the source of each of the components of the compositions shown in Tables 2-5 are shown in Table 1 as follows:

TABLE 1

| | Commercially Available | |
|---|---|---|
| Composition | Form | Source |
| Sodium dodecylbenzene sulfonate | Cola ® Det A40-S | Colonial Chemical, Inc. |
| | Calsoft ® F90 | Pilot Chemical Company |
| Sodium lauryl sulfate | Carsonol ® SLS | Lonza Inc. |
| Ammonium lauryl ether sulfate | Colonial ® ALES 60 | Colonial Chemical, Inc. |
| Triethanolamine C₁₈ alkyl ether | Cola ® Fax 3690 or Cola ® Lube | Colonial Chemical Inc. |
| phosphate | 3407 CI reacted with | |
| | triethanolamine | |
| Triethanolamine C₁₀-C₁₂ alkyl | Cola ® Fax 3690 reacted with | Colonial Chemical Inc. |
| ether phosphate | triethanolamine | |
| Isopropanolamine C₆-C₈ alkyl | Witcolate ™ 1259 | Akzo Nobel |
| ether sulfate | | |
| Monoethanolamine C₁₀-C₁₂ alkyl | Cola ® Fax 3690 reacted with | Colonial Chemical Inc. |
| ether phosphate | monoethanolamine | |
| C₁₂-C₁₆ alkyl polyglycoside | Glucopon ® 625 | Cognis Corp. |
| Dimethyl dodecylamine oxide | Barlox ® 12 | Lonza Inc. |
| C₈-C₁₀ alkyl polyglycoside | Glucopon ® 215 CSUP or | Cognis Corp. |
| | Glucopon ® 225DK | Cognis Corp. |
| C₈ alkyl polyglycoside | Glucopon ® 215 CSUP | Cognis Corp. |
| N-octyl-2-pyrrolidone | Surfadone ® LP 100 | ISP Technologies Inc. |
| Sodium dicarboxyethyl C₈-C₁₆ | Cola ® Teric AP | Colonial Chemical, Inc. |
| alkyl phosphoethyl imidazoline | | |
| C₁₂-C₁₄ acylamido propyl | Cola ® Teric COAB | Colonial Chemical, Inc. |
| dimethyl betaine | | |
| 1 hydroxyethyl C₈-C₁₂ alkyl | Cola ® Zoline C | Colonial Chemical, Inc. |
| imidazoline | | |
| Polysaccharide | Kelzan ® ST | CP Kelco |

Table 2 shows extinguishment times for firefighting and cooling compositions that have undesirably long extinguishment times.

TABLE 2

| | 2A | 2B | 2C | 2D | 2E | 2F | 2G | 2H |
|---|---|---|---|---|---|---|---|---|
| Anionic | | | | | | | | |
| sodium dodecylbenzene | 34 | 34 | 34 | 34 | 34 | | | |
| sulfonate | | | | | | | | |
| sodium lauryl sulfate | | | | | | 34 | | |
| ammonium lauryl ether sulfate | | | | | | | 34 | 34 |
| Nonionic | | | | | | | | |
| C12-C16 alkyl polyglycoside | | 3 | | 3 | | | 3 | |
| dimethyl dodecylamine oxide | 3 | | 3 | | 3 | 3 | 3 | 3 |
| Amphoteric | | | | | | | | |
| sodium dicarboxyethyl C8-C16 | | | 3 | 3 | | | | |
| alkyl phosphoethyl imidazoline | | | | | | | | |
| C12-C14 acylamido propyl | 4 | 4 | | | 4 | 4 | 4 | 4 |
| dimethylbetaine | | | | | | | | |
| Citric acid | | | | | | | 0.1 | 0.1 |
| sodium chloride | | | | | | | 0.1 | 0.1 |
| polysaccharide | 0.5 | 0.5 | 0.5 | 0.5 | | 0.5 | 0.5 | 0.5 |
| water | 58.5 | 58.5 | 59.5 | 59.5 | 59 | 58.5 | 55.3 | 58.3 |
| Extinguishment time | 50 | 47.2 | 46.7 | 51.1 | 48.9 | 42.1 | 43.2 | 41.5 |

Table 2 shows extinguishment times for firefighting and cooling compositions that have undesirably long extinguishment times. Each of compositions 2A-2H include sodium dodecylbenzene sulfonate, sodium lauryl sulfate or ammonium lauryl ether sulfate as the anionic surfactant. Composition 2E is equivalent to Composition A from U.S. Pat. No. 5,585,028 and demonstrates the undesirably long extinguishment time of the compositions disclosed in U.S. Pat. No. 5,585,028. As demonstrated by compositions 2A, 2B and 2G, the deleterious effects on extinguishment time caused by such anionic surfactants could not be overcome by the inclusion of C₁₂-C₁₆ alkyl polyglycoside as the nonionic surfactant.

TABLE 3
Table 3 shows extinguishment times for firefighting and cooling compositions,
including composition 3D which is commercially available as Baum's Novacool
UEF ®, that also have undesirably long extinguishment times.

| | 3A | 3B | 3C | 3D | 3E | 3F | 3G | 3H | 3I |
|---|---|---|---|---|---|---|---|---|---|
| Anionic | | | | | | | | | |
| isopropanolamine C6-C8 alkyl | 34 | 34 | 34 | 34 | 34 | 34 | 34 | 34 | 34 |
| ether sulfate | | | | | | | | | |
| Nonionic | | | | | | | | | |
| dimethyl dodecylamine oxide | 3 | 3 | 4 | 3 | 3 | 3 | 3 | 3 | 3 |
| Amphoteric | | | | | | | | | |
| C12-C14 acylamido propyl | 4 | 4 | 4 | 4 | 4 | 4 | 4 | 4 | 4 |
| dimethylbetaine | | | | | | | | | |
| Citric acid | 0.1 | | | 0.1 | | | 0.1 | 0.1 | |
| sodium chloride | 0.1 | | | | 0.1 | | 0.1 | | 0.1 |
| polysaccharide | 0.5 | | | | | 0.5 | | 0.5 | 0.5 |
| water | 58.3 | 59 | 58 | 58.9 | 58.9 | 58.5 | 58.8 | 58.4 | 58.4 |
| Extinguishment time | 37.2 | 35.4 | 28.1 | 34.1 | 33.1 | 32.7 | 36.5 | 34.6 | 35.1 |

Each of compositions 3A-3I include isopropanolamine C₆-C₈ alkyl ether sulfate as the anionic surfactant, dimethyl dodecylamine oxide as the nonionic surfactant, and C₁₂-C₁₄ acylamido propyl dimethylbetaine as the amphoteric surfactant. As demonstrated by compositions 3A-3I, the deleterious effect on extinguishment time caused by the dimethyl dodecylamine oxide nonionic surfactant, could not be overcome by the inclusion of the isopropanolamine C₆-C₈ alkyl ether sulfate anionic surfactant and the C₁₂-C₁₄ acylamido propyl dimethylbetaine amphoteric surfactant along with one or more of citric acid, sodium chloride and polysaccharide.

Table 4 shows extinguishment times for firefighting and cooling compositions according to certain embodiments of the present invention.

TABLE 4

| | 4A | 4B | 4C | 4D | 4E | 4F | 4G | 4H | 4I | 4J | 4K |
|---|---|---|---|---|---|---|---|---|---|---|---|
| Anionic | | | | | | | | | | | |
| isopropanolamine C6-C8 alkyl | 34 | 34 | 34 | 34 | 34 | 34 | 34 | 34 | 34 | 34 | 34 |
| ether sulfate | | | | | | | | | | | |
| triethanolamine C18 alkyl | | | | 7 | 7 | | | | | | |
| ethoxyphosphate | | | | | | | | | | | |
| triethanolamine C10-C12 alkyl | | | | | | 7 | 7 | | | | |
| ethoxy phosphate | | | | | | | | | | | |
| Nonionic | | | | | | | | | | | |
| C12-C16 alkyl polyglycoside | 3 | 3 | 3 | 4 | 4 | 4 | 4 | | | | |
| dimethyl dodecylamine oxide | | | | | | | | 3 | 3 | | |
| C8-C10 alkyl polyglycoside | | | | | | | | | | 4 | 4 |
| C8 alkyl polyglycoside | | | | | | | | | | | |
| N-octyl-2-pyrrolidone | | | | | | | | | | | |
| Amphoteric | | | | | | | | | | | |
| sodium dicarboxyethyl C8-C16 | 3 | 3 | | | | | | 3 | | | |
| alkyl phosphoethyl imidazoline | | | | | | | | | | | |
| C12-C14 acylamido propyl | | | 4 | | | | | | | 4 | 4 |
| dimethylbetaine | | | | | | | | | | | |
| 1 hydroxyethyl C8-C12 alkyl | | | | | 3 | | 3 | | 3 | | |
| imidazoline | | | | | | | | | | | |
| Citric acid | | | | | | | | | | 0.1 | |
| sodium chloride | | | | | | | | | | | 0.1 |
| polysaccharide | 0.5 | | 0.5 | | | | | 0.5 | | | |
| water | 59.5 | 60 | 58.5 | 55 | 52 | 55 | 52 | 59.5 | 60 | 58.9 | 58.9 |
| Extinguishment time | 10.3 | 12.6 | 15.7 | 9.9 | 9.6 | 10.7 | 6.8 | 10.5 | 10 | 8.1 | 9 |

| | 4L | 4M | 4N | 4O | 4P | 4Q | 4R | 4S | 4T | 4U | 4V |
|---|---|---|---|---|---|---|---|---|---|---|---|
| Anionic | | | | | | | | | | | |
| isopropanolamine C6-C8 alkyl | 34 | 34 | 34 | 34 | 34 | 34 | 34 | 34 | 34 | 34 | 34 |
| ether sulfate | | | | | | | | | | | |
| triethanolamine C18 alkyl | | | | | | | | | | | |
| ethoxyphosphate | | | | | | | | | | | |
| triethanolamine C10-C12 alkyl | | | | | 7 | | | | | | |
| ethoxy phosphate | | | | | | | | | | | |
| Nonionic | | | | | | | | | | | |
| C12-C16 alkyl polyglycoside | | | | | | | | | | | |
| dimethyl dodecylamine oxide | | | | | | | | | | | |
| C8-C10 alkyl polyglycoside | 4 | 4 | 4 | 4 | 4 | 4 | | | | | |
| C8 alkyl polyglycoside | | | | | | | 4 | 4 | 4 | 4 | 3 |
| N-octyl-2-pyrrolidone | | | | | | | | | | | 10 |
| Amphoteric | | | | | | | | | | | |
| sodium dicarboxyethyl C8-C16 | | | | | | | 3.5 | 4 | | | |
| alkyl phosphoethyl imidazoline | | | | | | | | | | | |
| C12-C14 acylamido propyl | 4 | 4 | 4 | 4 | | 4 | | | 3.5 | 4 | |
| dimethylbetaine | | | | | | | | | | | |
| 1 hydroxyethyl C8-C12 alkyl | | | | | 3 | | | | | | |
| imidazoline | | | | | | | | | | | |
| Citric acid | | 0.1 | 0.1 | | | | | | | | |
| sodium chloride | | 0.1 | | 0.1 | | | | | | | |
| polysaccharide | 0.5 | | 0.5 | 0.5 | | | | | | | |
| water | 57.5 | 57.8 | 57.4 | 57.4 | 52 | 58 | 58 | 58 | 58.5 | 58 | 53 |
| Extinguishment time | 7.5 | 8.4 | 7.9 | 8.1 | 6.3 | 6.9 | 6.3 | 6.4 | 8.85 | 8 | 9.7 |

Table 4 shows extinguishment times for firefighting and cooling compositions according to certain embodiments of the present invention in which the compositions include isopropanolamine C₆-C₈ alkyl ether sulfate as the anionic surfactant and in some cases an alkyl ether phosphate as an additional anionic surfactant. The compositions shown in Table 4 also include C₁₂-C₁₆, C₈-C₁₀ or C₈ alkyl polyglycoside or a combination of C₈ alkyl polyglycoside and an N-alkyl-2-pyrrolidone as the nonionic surfactant. The results for compositions 4A, 4B, 4C, 4E, 4G, 4J, 4K, 4L, 4M, 4N, 4O, 4P, 4Q, 4R, 4S, 4T and 4U shown in Table 4 demonstrate that highly effective firefighting and cooling compositions can be achieved when they include isopropanolamine C₆-C₈ alkyl ether sulfate as the anionic surfactant, an alkyl polyglycoside nonionic surfactant and an imidazoline or C₁₂-C₁₄ acylamido propyl dimethylbetaine as the amphoteric surfactant.

The results for compositions 4D and 4F shown in Table 4 demonstrate that highly effective fire fighting and cooling compositions can be achieved when they include two anionic surfactants, namely isopropanolamine C₆-C₈ alkyl ether sulfate and an alkyl ethoxyphosphate, and a C₁₂-C₁₆ alkyl polyglycoside as the nonionic surfactant but no amphoteric surfactant.

The results for composition 4V shown in Table 4 demonstrate that a highly effective fire fighting and cooling composition can be achieved when it includes isopropanolamine C₆-C₈ alkyl ether sulfate as the anionic surfactant and two nonionic surfactants, namely, C₈ alkyl polyglycoside and N-octyl-2-pyrrolidone but no amphoteric surfactant.

The results for compositions 4H and 4I shown in Table 4 demonstrate that highly effective fire fighting and cooling compositions can be achieved and the otherwise deleterious effects of dimethyl dodecylamine oxide can be overcome when they include both isopropanolamine C₆-C₈ alkyl ether sulfate as the anionic surfactant and an imidazoline such as sodium dicarboxyethyl C8-C₁₆ alkyl phosphoethyl imidazoline and 1-hydroxyethyl C₈-C₁₂ alkyl imidazoline as the amphoteric surfactant.

TABLE 5

| | 5A | 5B | 5C | 5D | 5E | 5F | 5G |
|---|---|---|---|---|---|---|---|
| Anionic | | | | | | | |
| monoethanolamine | 34 | 34 | 34 | 34 | 34 | 34 | 34 |
| C10-C12 | | | | | | | |
| alkyl ethoxy | | | | | | | |
| phosphate | | | | | | | |
| Nonionic | | | | | | | |
| C12-C16 alkyl | 3 | 3 | | | | | |
| polyglycoside | | | | | | | |
| dimethyl | | | 3 | 3 | 3 | | |
| dodecylamine oxide | | | | | | | |
| C8-C10 alkyl | | | | | | 3 | 3 |
| polyglycoside | | | | | | | |
| Amphoteric | | | | | | | |
| sodium dicarboxyethyl | 3 | | 3 | | | 3 | |
| C8-C16 | | | | | | | |
| alkyl phosphoethyl | | | | | | | |
| imidazoline | | | | | | | |
| C12-C14 acylamido | | | | 3 | | | |
| propyl | | | | | | | |
| dimethylbetaine | | | | | | | |
| 1 hydroxyethyl | | 3 | | | 3 | | 3 |
| C8-C12 alkyl | | | | | | | |
| imidazoline | | | | | | | |
| water | 60 | 60 | 60 | 60 | 60 | 60 | 60 |
| Extinguishment | 11.7 | 10.61 | 13.7 | 9.59 | 11.8 | 13.9 | 13.9 |
| time | | | | | | | |

Table 5 shows extinguishment times for firefighting and cooling compositions according to certain embodiments of the present invention in which the compositions include monoethanolamine C₁₀-C₁₂ alkyl ethoxy phosphate as the anionic surfactant. The compositions shown in Table 5 also include a C₁₂-C₁₆ or C₈₋₁₀ alkyl polyglycoside or dimethyl dodecylamine oxide as the nonionic surfactant. The results shown in Table 5 for compositions 5A, 5B, 5F and 5G demonstrate that highly effective firefighting and cooling compositions can be achieved when they include an alkyl ethoxy phosphate as the anionic surfactant, an alkyl polyglycoside as the nonionic surfactant and an imidazoline such as sodium dicarboxyethyl C₈-C₁₆ alkyl phosphoethyl imidazoline and l-hydroxyethyl C₈-C₁₂ alkyl imidazoline as the amphoteric surfactant. The results shown in Table 5 for compositions 5C, 5D and 5E demonstrate that highly effective firefighting and cooling compositions can be achieved and the otherwise deleterious effects of dimethyl dodecylamine oxide can be overcome when they include an alkyl ethoxy phosphate as the anionic surfactant.

As shown in Tables 2-5, all formulations showed extinguishment of the test fire. Also, as can be seen from a comparison of the extinguishment time results set forth in Tables 2, 4 and 5, all formulations that included sodium dodecylbenzene sulfonate as the anionic surfactant had significantly higher extinguishment times compared to formulations that included a combination of isopropanolamine C₆-C₈ alkyl ether sulfate as the anionic surfactant and an alkyl polyglycoside or a combination of an alkyl polyglycoside and an N-alkyl-2-pyrrolidone as the nonionic surfactant. (Tables 3, 4 and 5). In addition, as can be seen from a comparison of the extinguishment time results, the substitution of the conventional dimethyl dodecylamine oxide nonionic surfactant (Table 3) with the nonionic surfactants of the present embodiments (Tables 4 and 5), namely alkyl polyglycosides and N-alkyl-2-pyrrolidones resulted in significantly lower extinguishment times.

While the above discussion focuses on the intrinsic ability of the composition to put out a hydrocarbon or solvent fire, it should be understood that the composition also has cooling properties that can also be used as a retardant/protectant. The firefighting and cooling composition of the present invention is formulated such that large quantities of water are able to adhere to the surface of three dimensional objects such as houses, buildings, ships, airplanes, trees, etc. This is because the firefighting and cooling composition of the present invention enables the creation of a stable foam that includes large quantities of water. Hence, cooling effect can be achieved quickly by spraying the foam on a heated object (e.g.—coal, metal, etc.). In addition, the firefighting and cooling composition of the present invention can be used in protectant/retardant applications by spraying the foam on an object to be protected.

While the present invention has been described in terms of certain embodiments, those skilled in the art will recognize that the invention can be practiced with modification within the spirit and scope of the appended claims.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A fire fighting and cooling composition, comprising:
at least one non-ionic surfactant present at a concentration of from about 0.25% to about 13.0% by weight, selected from the group consisting of alkyl polyglycosides having a substituted or unsubstituted alkyl side chain of from 6 to 18 carbon atoms, N-alkyl-2-pyrrolidones having a substituted or unsubstituted alkyl side chain of from 8 to 10 carbon atoms, and combinations thereof;
at least one anionic surfactant present at a concentration of from 10.0% to 50.0% by weight selected from the group consisting of alkyl ether sulfates, alkyl ether phosphates, and combinations thereof; and
at least one amphoteric surfactant present at a concentration of from 0.5% to 15.0% by weight.

2. The fire fighting and cooling composition of claim 1 wherein the at least one non-ionic surfactant comprises an N-alkyl-2-pyrrolidone present at a concentration of from about 3.0% to about 12.0% by weight.

3. The fire fighting and cooling composition of claim 1 wherein the at least one non-ionic surfactant is present at a concentration of from about 3.0% to about 12.0% by weight.

4. The fire fighting and cooling composition of claim 1 wherein the at least one anionic surfactant comprises an alkyl ether sulfate having a formula of RO(C₂H₄O)ₓSO₃M where R is a substituted or unsubstituted alkyl group having from 6 to 10 carbon atoms, x ranges from 1 to 30, and M is ammonium or substituted ammonium.

5. The fire fighting and cooling composition of claim 1 wherein the at least one anionic surfactant comprises an alkyl ether phosphate having a formula of RO(C₂H₄O)_{y}PO₃M where R is a substituted or unsubstituted alkyl group having from 6 to 18 carbon atoms, y ranges from 1 to 30 and M is ammonium or substituted ammonium.

6. The fire fighting and cooling composition of claim 1 wherein the at least one anionic surfactant comprises an alkyl ether phosphate present at a concentration of from about 2.0% to about 8.0% by weight.

7. The fire fighting and cooling composition of claim 1 wherein the at least one amphoteric surfactant is present at a concentration of from about 1.0% to about 10.0% by weight.

8. The fire fighting and cooling composition of claim 1 wherein the at least one amphoteric surfactant has a formula of: 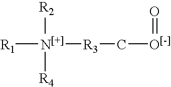
wherein R₁-R₄ are independently selected from the group consisting of substituted and unsubstituted alkyl constituents, substituted and unsubstituted cycloalkyl constituents, substituted and unsubstituted aryl constituents, and ethoxylated hydroxyl groups containing from 1 to 10 ethylene oxide units.

9. The fire fighting and cooling composition of claim 1 wherein the at least one amphoteric surfactant is selected from the group consisting of acylamidoalkylbetaines, alkyl imidazolines, and combinations thereof.

10. The fire fighting and cooling composition of claim 9 wherein the at least one amphoteric surfactant comprises an acylamidoalkylbetaine having a formula of: 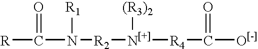
wherein R is a substituted or unsubstituted alkyl or alkylaryl group having from 6 to 12 carbon atoms, R₁ is a hydrogen or substituted or unsubstituted alkyl group having from 1 to 6 carbon atoms, R₂ is a substituted or unsubstituted alkylene group having from 1 to 10 carbon atoms, R₃ is a substituted or unsubstituted alkylene group having from 1 to 6 carbon atoms or an ethoxylated hydroxyl group containing from 1 to 10 ethylene oxide units, wherein the ethoxylated hydroxyl group has the formula:
HC—(OC₂H₅)₁₋₁₀
and where R₄ is a substituted or unsubstituted alkylene group containing from 1 to 6 carbon atoms.

11. The fire fighting and cooling composition of claim 10 wherein the acylamidoalkylbetaine comprises octylamidopropyldimethylbetaine.

12. The fire fighting and cooling composition of claim 1 wherein the at least one amphoteric surfactant is selected from the group consisting of dodecylamidopropylbetaine, dimethylbetaine, C₈ acylamidohexyldiethylbetaine, C₁₂₋₁₄ acylamidopropylbetaine, C₆₋₁₆ sodium dicarboxyethyl alkyl phosphoethyl imidazoline, C₈₋₁₂ alkyl imidazoline, and combinations thereof.

13. The fire fighting and cooling composition of claim 1 further comprising a water soluble polysaccharide selected from the group consisting of xanthan gum, guar gum and combinations thereof.

14. The fire fighting and cooling composition of claim 1, further comprising an additive selected from the group consisting of alkali metal salts, alkaline earth metal salts, organic acids and combinations thereof.

15. The fire fighting and cooling composition of claim 14, wherein the additive is present at a concentration of from about 0.01% to about 5.0% by weight.

16. The fire fighting and cooling composition of claim 1 present in an aqueous solution with a concentration ranging from about 0.01% to about 12.0% by volume.

17. The fire fighting and cooling composition of claim 1 present in an aqueous solution with a concentration ranging from about 0.1% to about 6.0% by volume.

18. A foam-forming composition for fire fighting and cooling, comprising:
(a) water; and
(b) a surfactant mixture present in the composition at a concentration of from about 0.01% to about 12.0% by volume, the surfactant mixture comprising:
(i) at least one non-ionic surfactant selected from the group consisting of alkyl polyglycosides having a substituted or unsubstituted alkyl side chain of from 6 to 18 carbon atoms, N-alkyl-2-pyrrolidones having a substituted or unsubstituted alkyl side chain of from 8 to 10 carbon atoms, and combinations thereof;
(ii) at least one anionic surfactant selected from the group consisting of:
an alkyl ether sulfate having a formula of RO(C₂H₄O)ₓSO₃M where R is a substituted or unsubstituted alkyl group having from 6 to 10 carbon atoms, x ranges from 1 to 30, and M is ammonium or substituted ammonium; and
an alkyl ether phosphate having a formula of RO(C₂H₄O)_{y}PO₃M where R is a substituted or unsubstituted alkyl group having from 6 to 18 carbon atoms, y ranges from 1 to 30, and M is ammonium or substituted ammonium; and
(iii) at least one amphoteric surfactant selected from the group consisting of dodecylamidopropylbetaine, dimethylbetaine, C₈ acylamidohexyldiethylbetaine, C₁₂₋₁₄ acylamidopropylbetaine, C₆₋₁₆ sodium dicarboxyethyl alkyl phosphoethyl imidazoline, C₈₋₁₂ alkyl imidazoline, and combinations thereof.

19. A fire fighting and cooling composition, comprising:
at least one non-ionic surfactant present at a concentration of from about 0.25% to about 13.0% by weight selected from the group consisting of alkyl polyglycosides having a substituted or unsubstituted alkyl side chain of from 6 to 18 carbon atoms, N-alkyl-2-pyrrolidone having a substituted or unsubstituted alkyl side chain of from 8 to 10 carbon atoms, and combinations thereof, and;
at least one anionic surfactant present at a concentration of from about 10.0% to about 50.0% by weight selected from the group consisting of alkyl ether sulfates, alkyl ethoxy phosphates, and combinations thereof.

20. The fire fighting and cooling composition of claim 19 further comprising at least one amphoteric surfactant.

21. A fire fighting and cooling composition, comprising:
a non-ionic surfactant present at a concentration of from about 0.25% to about 13.0% by weight comprising dimethyl dodecylamine oxide;
an anionic surfactant present at a concentration of from 10.0% to 50.0% by weight selected from the group consisting of isopropanolamine C₆-C₈ alkyl ether sulfate and monoethanolamine C₁₀-C₁₂ alkyl ethoxy phosphate; and
an amphoteric surfactant present at a concentration of from 0.5% to 15.0% by weight, wherein when the anionic surfactant is isopropanolamine C₆-C₈ alkyl ether sulfate the amphoteric surfactant is an imidazoline.
